(19) United States
(12) Patent Application Publication
(10) Pub. No.: US 2021/0033992 A1
(43) Pub. Date: Feb. 4, 2021

(54) ELECTROPHOTOGRAPHIC PHOTOSENSITIVE MEMBER, PROCESS CARTRIDGE, AND ELECTROPHOTOGRAPHIC APPARATUS

(71) Applicant: CANON KABUSHIKI KAISHA, Tokyo (JP)

(72) Inventors: Mai Kaku, Suntou-gun (JP); Koichi Nakata, Tokyo (JP); Haruki Mori, Nagareyama-shi (JP); Shubun Kujirai, Toride-shi (JP)

(21) Appl. No.: 16/936,642

(22) Filed: Jul. 23, 2020

(30) Foreign Application Priority Data
Jul. 31, 2019 (JP) 2019-141215

(51) Int. Cl. G03G 5/06; G03G 5/047; G03G 5/05; G03G 21/18; G03G 15/00

(52) U.S. Cl. CPC G03G 5/0638; G03G 5/047; G03G 15/75; G03G 21/1814; G03G 5/0542

(57) ABSTRACT

Provided is an electrophotographic photosensitive member including: a support, a photosensitive layer provided on the support, and a surface layer provided on the photosensitive layer, wherein the surface layer of the electrophotographic photosensitive member contains a cured product of a composition containing a charge transporting substance having a polymerizable functional group, a compound having a specific structure, a fluororesin particle, and polyvinyl acetal.

### BACKGROUND OF THE INVENTION

### Field of the Invention

The present invention relates to an electrophotographic photosensitive member, a process cartridge including the electrophotographic photosensitive member, and an electrophotographic apparatus including the electrophotographic photosensitive member.

### Description of the Related Art

Recently, a cured surface layer has been formed by using a curable resin (crosslinkable resin) in a surface layer, in order to increase abrasion resistance of an electrophotographic photosensitive member. The curable resin is formed by a reaction of a monomer having a polymerizable functional group. In this case, a cured product designed by appropriately combining a monomer having no charge transport structure with a charge transport monomer is used in order to optimize a function.

In addition, in order to reduce a surface energy of the electrophotographic photosensitive member, a surface layer of the electrophotographic photosensitive member is allowed to contain a fluororesin particle. Japanese Patent Application Laid-Open No. 2012-203253 discloses an electrophotographic photosensitive member having a surface layer containing a crosslinked product containing a charge transporting substance having a polymerizable functional group, a fluororesin particle, an oligomer containing a fluorine atom, and a specific solvent.

In addition, Japanese Patent Application Laid-Open No. 2013-257416 discloses an electrophotographic photosensitive member having a surface layer containing no curable resin and containing a fluororesin particle and a polyvinyl acetal resin as a dispersion stabilizer.

### SUMMARY OF THE INVENTION

According to findings by the inventors of the present invention, in the case where the fluororesin particle is contained in the surface layer of the electrophotographic photosensitive member as disclosed in Japanese Patent Application Laid-Open No. 2012-203253, sufficient image quality may not be obtained during repeated use of the electrophotographic photosensitive member under a low humidity environment. It is presumed that this is because the fluororesin particle is charged itself due to rubbing of the electrophotographic photosensitive member with a toner or another member.

In addition, in the case where the surface layer contains the charge transporting substance, charges move from the charge transporting substance to the fluororesin particle, and thus, the fluororesin particle is likely to be further intensely charged. As a result, it is considered that a Coulomb force acting between the toner and the surface layer of the electrophotographic photosensitive member is greatly disturbed, and thus, it is difficult to release the toner from the electrophotographic photosensitive member. In this case, a sufficient reproducibility (dot, fine line, or the like) of the obtained image may not be obtained.

As disclosed in Japanese Patent Application Laid-Open No. 2013-257416, it is expected that in the photosensitive member containing the polyvinyl acetal resin as a dispersion stabilizer for the fluororesin particle, charging of the fluororesin particle is suppressed, and thus, the toner is easily released from the electrophotographic photosensitive member. However, since the surface layer of the electrophotographic photosensitive member disclosed in Japanese Patent Application Laid-Open No. 2013-257416 contains no curable resin, the surface layer of the electrophotographic photosensitive member has a low abrasion resistance.

On the other hand, in a surface layer having abrasion resistance by a curable resin, removal caused by abrasion of a surface chemically degraded does not occur, and a charge transporting substance in the surface is likely to be chemically changed by a stress such as charging. The chemical change of the charge transporting substance may cause a phenomenon in which an image output under a high temperature and high humidity environment becomes unclear (hereinafter, referred to as “image deletion”).

According to the findings by the inventors of the present invention, in a case where a curable resin is used in a surface layer containing a fluororesin particle and a polyvinyl acetal resin, excellent image reproducibility and high abrasion resistance under a low humidity environment may be obtained; however, image deletion under a high temperature and high humidity environment may be remarkable. It is presumed that this is because water repellency of a surface of the photosensitive member is reduced due to a hydrophilic portion of the polyvinyl acetal resin, and thus, the image deletion is more likely to occur.

An aspect of the present invention is to provide an electrophotographic photosensitive member capable of reducing a potential fluctuation, increasing image reproducibility under a low humidity environment, and suppressing image deletion under a high temperature and high humidity environment, during repeated use of the electrophotographic photosensitive member. Another aspect of the present invention is to provide a process cartridge including the electrophotographic photosensitive member, and an electrophotographic apparatus including the electrophotographic photosensitive member.

The above object is achieved by the following present invention. An electrophotographic photosensitive member according to an aspect of the present invention includes a support, a photosensitive layer provided on the support, and a surface layer provided on the photosensitive layer, wherein the surface layer contains a cured product of a composition containing a charge transporting substance having a polymerizable functional group, a compound represented by the following Formula (1), a fluororesin particle, and polyvinyl acetal,

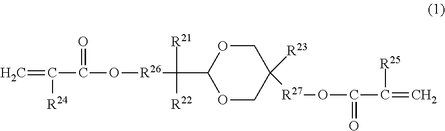

in Formula (1), R²¹ and R²² each independently represent an alkyl group having 1 or more and 4 or fewer carbon atoms or a substituted or unsubstituted aryl group, a substituent included in the aryl group is an alkyl group having 4 or fewer carbon atoms, R²¹ and R²² may be bonded to each other to form a ring, R²³ represents an alkyl group having 1 or more and 4 or fewer carbon atoms, R²⁴ and R²⁵ each independently represent a hydrogen atom or a methyl group, and R²⁶ and R²⁷ each independently represent an alkylene group having 1 or more and 4 or fewer carbon atoms.

A process cartridge according to another aspect of the present invention integrally supports the electrophotographic photosensitive member and at least one unit selected from the group consisting of a charging unit, a developing unit, and a cleaning unit, and is detachably attachable to a main body of an electrophotographic apparatus.

An electrophotographic apparatus according to still another aspect of the present invention includes the electrophotographic photosensitive member, a charging unit, an exposing unit, a developing unit, and a transfer unit.

According to the present invention, it is possible to provide an electrophotographic photosensitive member capable of reducing a potential fluctuation, increasing image reproducibility under a low humidity environment, and suppressing image deletion under a high temperature and high humidity environment, during repeated use of the electrophotographic photosensitive member. In addition, according to the present invention, it is possible to provide a process cartridge including the electrophotographic photosensitive member, and an electrophotographic apparatus including the electrophotographic photosensitive member.

Further features of the present invention will become apparent from the following description of exemplary embodiments with reference to the attached drawings.

### BRIEF DESCRIPTION OF THE DRAWINGS

FIG. 1 is a view schematically illustrating an example of a process cartridge including an electrophotographic photosensitive member.

FIG. 2 is a view schematically illustrating an example of an electrophotographic apparatus including an electrophotographic photosensitive member.

FIG. 3 is a view schematically illustrating an example of a press-contact shape transfer processing device used for surface-processing of an electrophotographic photosensitive member.

FIG. 4A is a top view illustrating an arrangement of convex portions of a mold in the press-contact shape transfer processing device.

FIG. 4B is a cross-sectional view illustrating a shape of the convex portion of the mold in the press-contact shape transfer processing device.

FIG. 4C is a cross-sectional view illustrating the shape of the convex portion of the mold in the press-contact shape transfer processing device.

### DESCRIPTION OF THE EMBODIMENTS

In an electrophotographic photosensitive member according to the present invention, a surface layer contains a cured product of a composition containing a charge transporting substance having a polymerizable functional group, a compound represented by the following Formula (1), a fluororesin particle, and polyvinyl acetal,

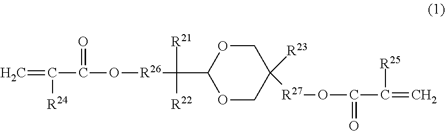

in Formula (1), R²¹ and R²² each independently represent an alkyl group having 1 or more and 4 or fewer carbon atoms or a substituted or unsubstituted aryl group, a substituent included in the aryl group is an alkyl group having 4 or fewer carbon atoms, R²¹ and R²² may be bonded to each other to form a ring, R²³ represents an alkyl group having 1 or more and 4 or fewer carbon atoms, R²⁴ and R²⁵ each independently represent a hydrogen atom or a methyl group, and R²⁶ and R²⁷ each independently represent an alkylene group having 1 or more and 4 or fewer carbon atoms.

When polyvinyl acetal is used in a cured surface layer in which fluororesin particles are dispersed, image reproducibility in a low humidity environment becomes high. The reason for this is presumed that, as described above, chargeability of the fluororesin particle is relieved, and a phenomenon in which the fluororesin particle is charged due to rubbing with a toner or another member can thus be suppressed.

Meanwhile, when polyvinyl acetal is used in the surface layer, water repellency of a surface of the electrophotographic photosensitive member may be reduced, and image deletion under a high temperature and high humidity environment may be remarkable. On the contrary, in the present invention, the surface layer contains the cured product of the composition containing the compound represented by Formula (1), such that the image deletion is suppressed. The following mechanism is presumed as the reason for this.

First, the compound represented by Formula (1) is a compound having a high aggregation energy due to a structure thereof, and the surface layer has the structure derived from the compound represented by Formula (1), such that denseness of a film of the surface layer is increased. Therefore, moisture permeability to the surface layer can be suppressed.

In addition, similarly to the polyvinyl acetal, the compound represented by Formula (1) has an acetal ring structure in a molecule. Accordingly, it is considered that the compound represented by Formula (1) is likely to interact with the polyvinyl acetal due to affinity with the polyvinyl acetal, and water absorption is suppressed by the polyvinyl acetal.

Hereinafter, each of constituent materials will be described in detail.

Polyvinyl Acetal

Polyvinyl acetal is a resin having a structure obtained by reacting polyvinyl alcohol with aldehyde. In this structure, a butyral group, an acetyl group, and a hydroxyl group are included in a molecule. By changing a ratio or a polymerization degree (molecular weight) of each of these three groups, an excessive charging of the fluororesin particle during repeated use of the electrophotographic photosensitive member can be controlled.

In the present invention, polyvinyl acetal in which a molar ratio of the hydroxyl group present in the polyvinyl acetal is 25 mol % or more and 40 mol % or less is preferably used. By setting the molar ratio to the above range, it is possible to effectively prevent the excessive charging of the fluororesin particle and aggregation of the fluororesin particles when forming the surface layer.

Examples of the polyvinyl acetal can include S-LEC B, K(KS), and SV series (manufactured by SEKISUI CHEMICAL CO., LTD.), and MOWITAL series (manufactured by KURARAY CO., LTD.). More specifically, examples thereof can include S-LEC BM-1 (amount of hydroxyl group: 34 mol %, butyralization degree: 65±3 mol %, molecular weight: 40,000), BH-3 (amount of hydroxyl group: 34 mol %, butyralization degree: 65±3 mol %, molecular weight: 110,000), BH-6 (amount of hydroxyl group: 30 mol %, butyralization degree: 69±3 mol %, molecular weight: 920,000), BX-1 (amount of hydroxyl group: 33±3 mol %, acetalization degree: 66 mol %, molecular weight: 100,000), BX-5 (amount of hydroxyl group: 33±3 mol %, acetalization degree: 66 mol %, molecular weight: 130,000), BM-2 (amount of hydroxyl group: 31 mol %, butyralization degree: 68±3 mol %, molecular weight: 520,000), BM-5 (amount of hydroxyl group: 34 mol %, butyralization degree: 65±3 mol %, molecular weight: 530,000), BL-1 (amount of hydroxyl group: 36 mol %, butyralization degree: 63±3 mol %, molecular weight: 190,000), BL-1H (amount of hydroxyl group: 30 mol %, butyralization degree: 69±3 mol %, molecular weight: 20,000), BL-2 (amount of hydroxyl group: 36 mol %, butyralization degree: 63±3 mol %, molecular weight: 270,000), BL-2H (amount of hydroxyl group: 29 mol %, butyralization degree: 70±3 mol %, molecular weight: 280,000), BL-10 (amount of hydroxyl group: 28 mol %, butyralization degree: 71±3 mol %, molecular weight: 150,000), BL-S (amount of hydroxyl group: 22 mol %, butyralization degree: 74±3 mol %, molecular weight: 23,000), and KS-10 (amount of hydroxyl group: 25 mol %, acetalization degree: 65±3 mol %, molecular weight: 170,000), and MOWITAL B145 (amount of hydroxyl group: 21 to 27 mol %, acetalization degree: 67 to 75 mol %) and B16H (amount of hydroxyl group: 26 to 31 mol %, acetalization degree: 66 to 74 mol %, molecular weight: 1 to 20,000). These polyvinyl acetals may be used alone or as a mixture of two or more thereof.

In the present invention, a content of the polyvinyl acetal in the composition for forming the surface layer is preferably 0.1% by mass or more and 15.0% by mass or less with respect to a content of the fluororesin particle in the composition. Furthermore, the content of the polyvinyl acetal in the composition is more preferably 3.0% by mass or more and 10.0% by mass or less. When the content of the polyvinyl acetal in the composition is 0.1% by mass or more, chargeability of the fluororesin particle is relieved, and the phenomenon in which the fluororesin particle is charged due to rubbing with a toner or another member can thus be suppressed. In addition, when the content of the polyvinyl acetal in the composition is 15.0% by mass or less, transport charges derived from the polyvinyl acetal present in the vicinity of the charge transporting substances are not trapped, and thus, a hopping phenomenon between the charge transporting substances is not inhibited. As a result, potential fluctuation stability or image reproducibility can be sufficiently obtained.

In the present invention, it is preferable that the polyvinyl acetal is contained in the vicinity of the fluororesin particle in order to further enhance the effect of the present invention. Therefore, the polyvinyl acetal and the fluororesin particle are preferably contained in the surface layer as described below rather than being randomly contained in the surface layer. That is, it is preferable that the polyvinyl acetal and the fluororesin particle are contained in the surface layer via an environment or procedure in which the fluororesin particle is easily coated with the polyvinyl acetal in advance.

In a preferred method for coating a fluororesin particle with a polyvinyl acetal, the following procedure is as follows. First, fluororesin particles are added to a solution in which polyvinyl acetal is dissolved in an organic solvent, and the mixture is stirred. Subsequently, the fluororesin particles are uniformly dispersed while being coated with the polyvinyl acetal by applying a dispersion shear by a dispersion unit such as a bead mill to prepare a dispersion.

A charge transporting substance and a compound represented by Formula (1) are added to and dissolved in the obtained dispersion to prepare a coating liquid for a surface layer. The coating liquid for a surface layer is applied onto a photosensitive layer to form a surface layer, such that it is possible to obtain the surface layer containing the fluororesin particle with which the polyvinyl acetal is effectively coated.

In the coating state of the polyvinyl acetal with respect to the fluororesin particle, a thickness of a coating layer thereof is preferably 1 nm or more and 50 nm or less, more preferably 3 nm or more and 30 nm or less, and still more preferably 5 nm or more and 20 nm or less.

In addition, the content of the polyvinyl acetal in the composition for forming the surface layer is preferably 10% by mass or less and more preferably 6% by mass or less with respect to the charge transporting substance in the composition. The polyvinyl acetal is present around the fluororesin particle, such that the excessive charging of the fluororesin particle in a repetitive electrophotographic process can be prevented. However, on the other hand, when the content of the polyvinyl acetal is too large, the polyvinyl acetal acts as a trap that inhibits the hopping phenomenon between the charge transporting substances. Therefore, it is considered that the above range is preferable.

Compound Represented by Formula (1)

In the present invention, the compound represented by Formula (1) is a polymerizable monomer having an acetal ring in a molecule and having an acryloyloxy group or a methacryloyloxy group at a terminal thereof. The surface layer of the present invention contains a cured product obtained by copolymerizing the compound and the charge transporting substance having the polymerizable functional group.

At least one of R²¹ and R²² in Formula (1) is preferably an alkyl group having 2 or more carbon atoms.

In addition, the alkylene group represented by R²⁶ or R²⁷ in Formula (1) is preferably a methylene group or an ethylene group, from the viewpoints of denseness and strength of the film.

Hereinafter, specific examples of the compound represented by Formula (1) will be described. However, it is not particularly limited to the following examples.

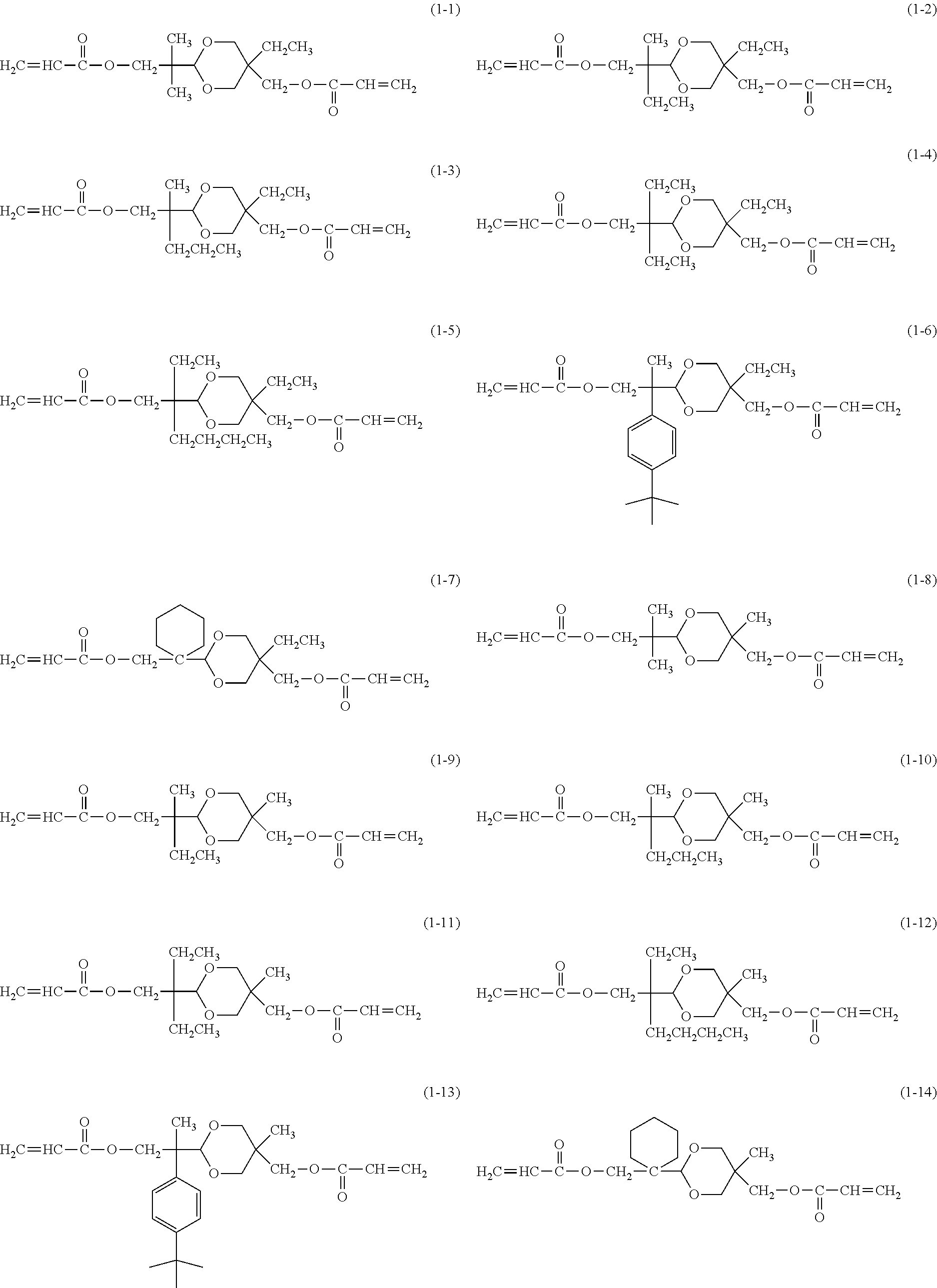

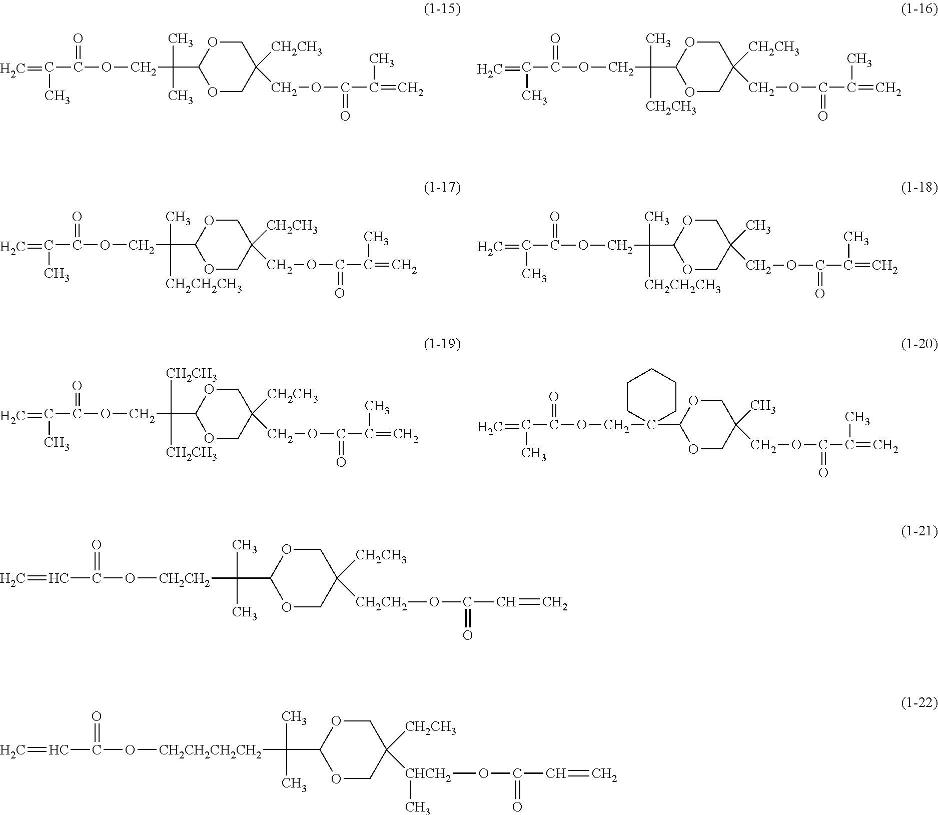

Among them, a compound represented by Formula (1-3) and a compound represented by Formula (1-4) are particularly preferable from the viewpoint of suppressing image deletion.

A representative synthesis example of the compound represented by Formula (1) will be described below.

<Synthesis Example of Compound Represented by Formula (1)>

A synthesis example of a difunctional polymerizable acrylic compound represented by Formula (1-3) will be described.

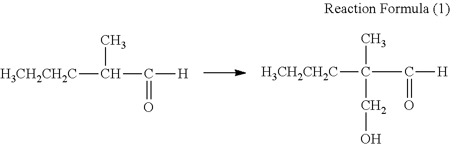

First, 50 parts of 2-methylvaleraldehyde, 40.5 parts of 37% formaldehyde, and 8.5 parts of benzyltrimethylammonium hydroxide (40% aqueous solution) were mixed each other in an autoclave. A pressure in the autoclave was increased to 0.5 MPa by using nitrogen, and the mixture was stirred at 90° C. for 1 hour. After the reaction was completed, the reaction solution was cooled to room temperature and separated. In addition, the separated solution was washed with water and condensed to obtain about 50 parts of a colorless liquid.

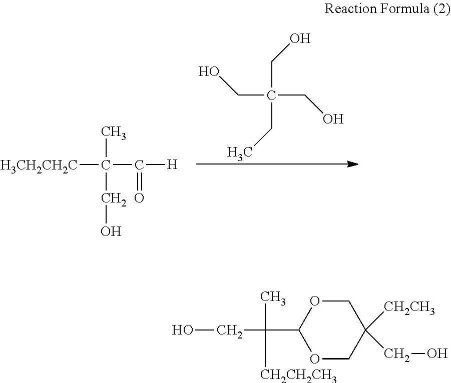

50 parts of the obtained colorless liquid were mixed with 52 parts of trimethylolpropane and 1 part of p-toluenesulfonic acid. The mixture was stirred at room temperature overnight. After the reaction was completed, the reaction product was purified by column chromatography (silica gel and ethyl acetate were used as a stationary phase and a mobile phase, respectively), thereby obtaining about 30 parts of a colorless oily substance.

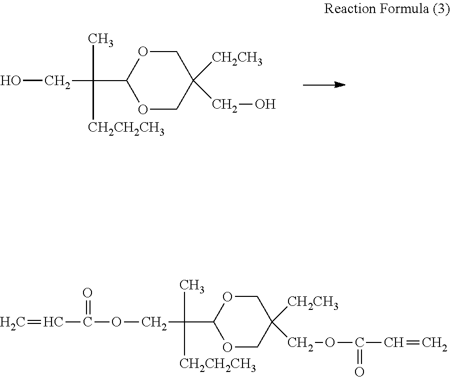

The obtained colorless oily substance and acrylic acid were dehydrated and condensed by using chloroform, triethylamine, and dicyclohexylcarbodiimide as a solvent, a catalyst, and a dehydration-condensation agent, respectively.

The filtrate of the reaction product was condensed and purified by column chromatography (silica and n-hexane/ethyl acetate (4/1) were used as a stationary phase and a mobile phase, respectively), thereby obtaining a colorless liquid substance. In addition, 4-methoxyphenol was added as a polymerization inhibitor after the amount thereof was adjusted so that a concentration thereof was 100 ppm.

By doing so, the compound represented by Formula (1-3) was obtained.

Similarly, another polymerizable compound represented by Formula (1) can be synthesized.

In the present invention, the content of the polyvinyl acetal in the composition for forming the surface layer is preferably 0.8% by mass or more and 10.0% by mass or less with respect to a content of the compound represented by Formula (1) in the composition. When the content of the polyvinyl acetal in the composition is 0.8% by mass or more, the phenomenon in which the fluororesin particle is charged can be further suppressed. In addition, when the content of the polyvinyl acetal in the composition is 10.0% by mass or less, the image deletion can be further sufficiently suppressed by a structure of the compound represented by Formula (1).

Charge Transporting Substance Having Polymerizable Functional Group

Examples of the polymerizable functional group included in the charge transporting substance can include an acryloyloxy group, a methacryloyloxy group, an alkoxysilyl group, and an epoxy group. Among them, an acryloyloxy group or a methacryloyloxy group is preferable.

A content of the charge transporting substance in the composition for forming the surface layer is preferably 50% by mass with respect to a total content of the charge transporting substance, the compound represented by Formula (1) in the composition, the fluororesin particle, and the polyvinyl acetal. The hopping phenomenon between the charge transporting substances may be partially inhibited by the trap of the transport charges derived from the polyvinyl acetal in the surface layer. However, when the content of the charge transporting substance having the polymerizable functional group in the composition is 50% by mass or more with respect to the total content of the charge transporting substance, the compound represented by Formula (1) in the composition, the fluororesin particle, and the polyvinyl acetal, the trap is unlikely to occur. As a result, potential fluctuation stability and image reproducibility under a low humidity environment may be further improved during repeated use of the electrophotographic photosensitive member.

Hereinafter, specific examples of the charge transporting substance having the polymerizable functional group will be described. However, it is not particularly limited to the following examples.

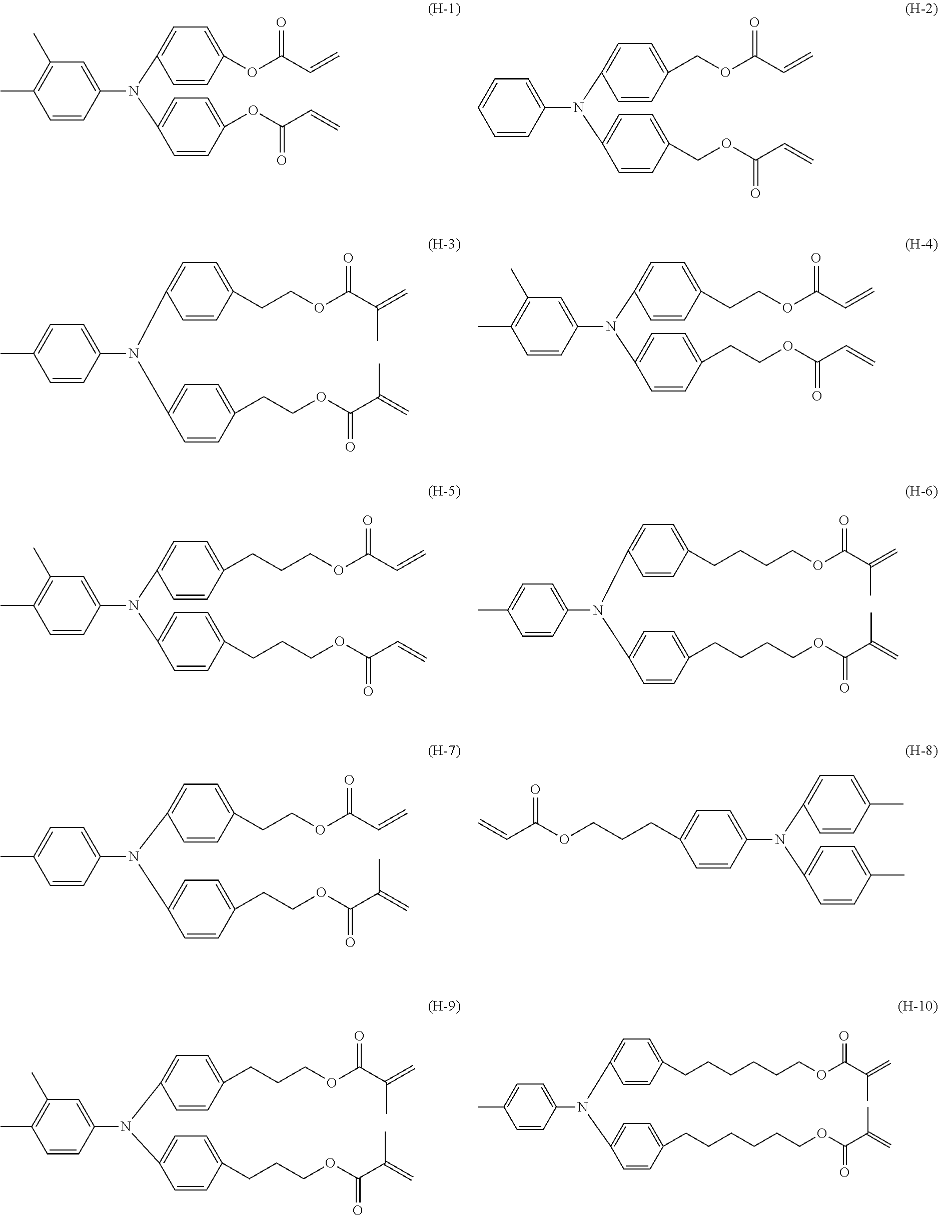

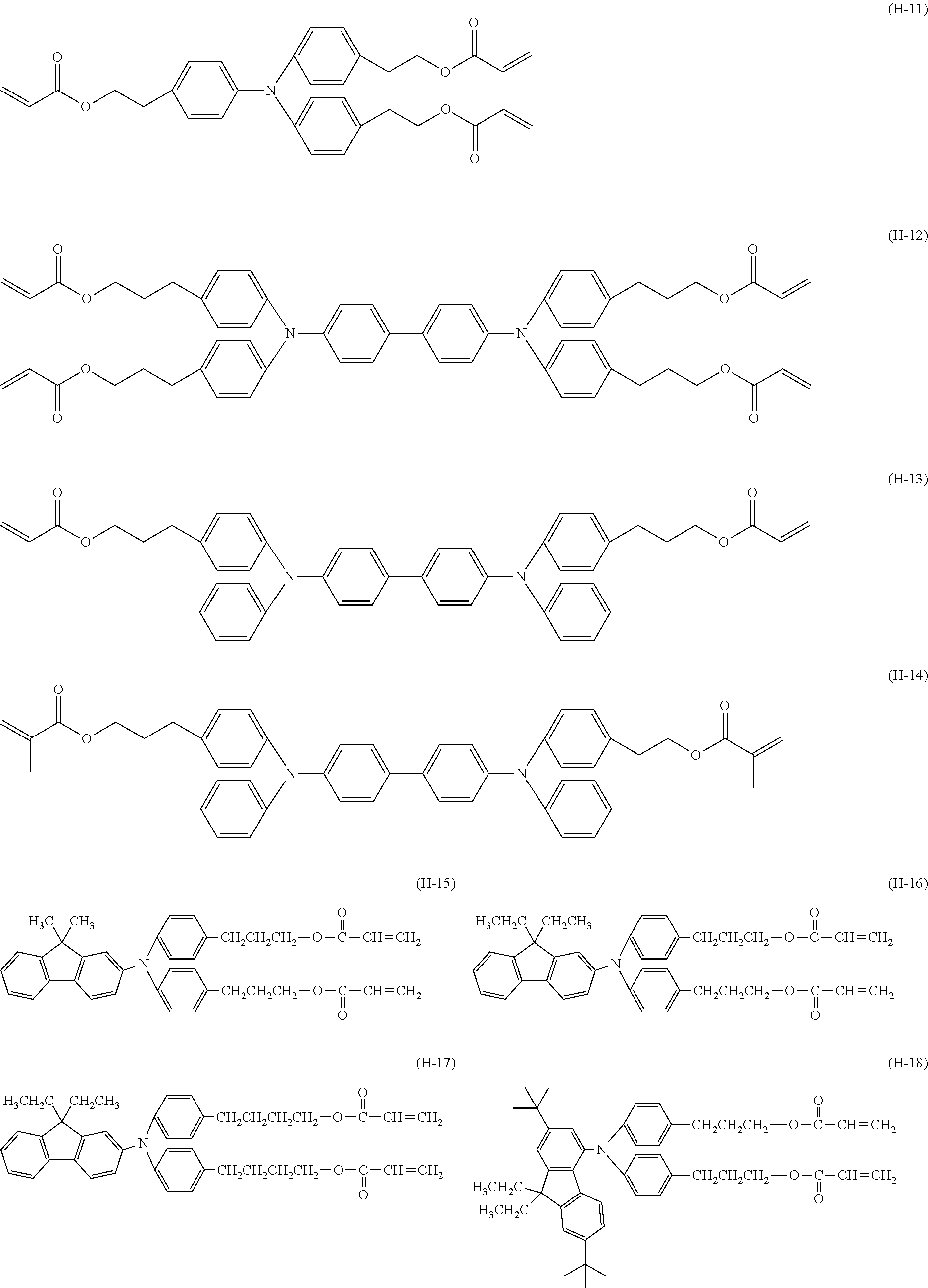

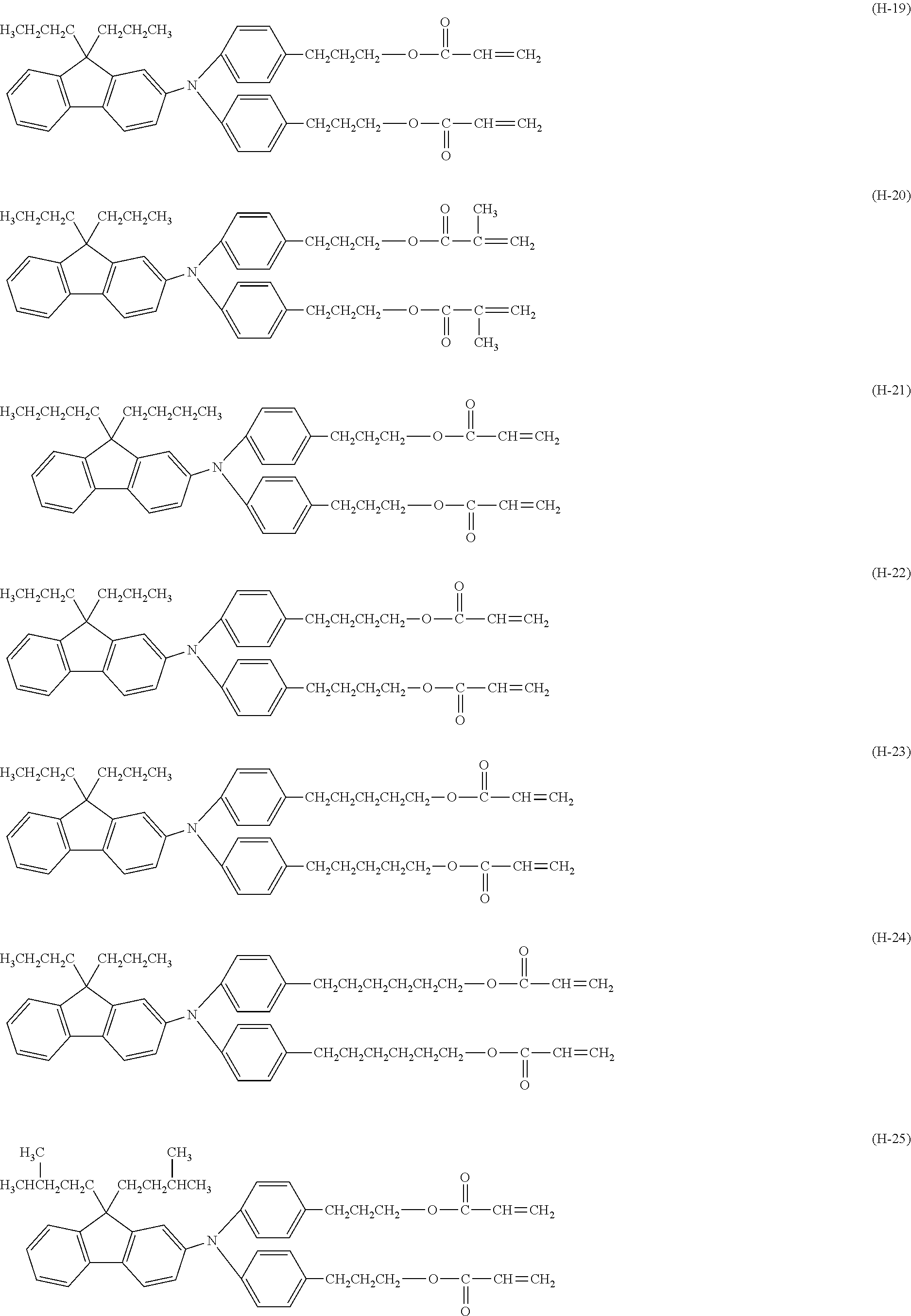

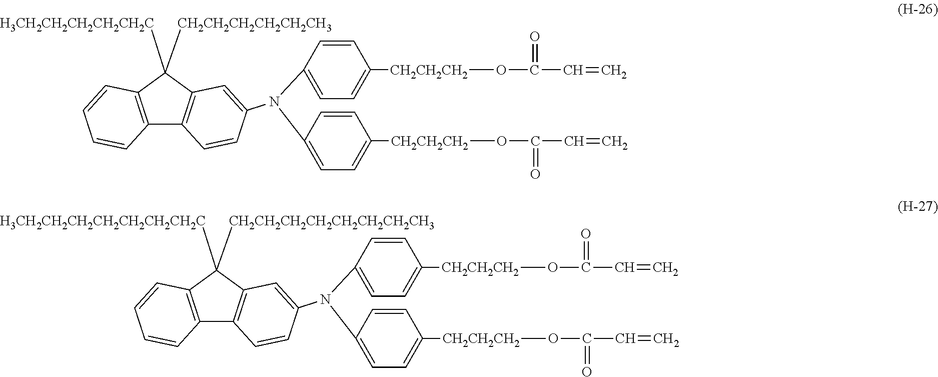

Among them, compounds represented by Formulas (H-16) to (H-27) are particularly preferable from the viewpoint of the potential fluctuation stability. Furthermore, the compound represented by Formula (H-16) or the compound represented by Formula (H-19) is more preferable.

Fluororesin Particle

The fluororesin particle is not particularly limited, but a tetrafluoroethylene resin particle, a trifluoroethylene resin particle, a tetrafluoroethylene hexafluoropropylene resin particle, a vinyl fluoride resin particle, a vinylidene fluoride resin particle, or a difluoroethylene dichloride resin particle is preferably used. In addition, a copolymer particle thereof is preferably used. Among them, a tetrafluoroethylene resin particle is more preferably used.

An average primary particle diameter of the fluororesin particles is preferably 0.5 μm or less and more preferably 0.3 μm or less. In addition, the average primary particle diameter of the fluororesin particles is preferably 0.05 μm or more, in order to particularly improve releasability of toner particles from the surface of the electrophotographic photosensitive member.

The content of the fluororesin particle in the surface layer is preferably 1% by mass or more and 40.0% by mass or less with respect to a total mass of the surface layer.

In addition, a polymer containing a fluorinated alkyl group may also be contained in order to prevent aggregation of the fluororesin particles in the surface layer. A content of the polymer is preferably 3.0% by mass or more and 10.0% by mass or less with respect to the content of the fluororesin particle in the surface layer.

Antifoaming Agent

It is more preferable that the composition for forming the surface layer contains an antifoaming agent. In particular, in a case where the fluororesin particle is used as a dispersion with a high concentration such as 30% by mass, foaming of the dispersion may occur. Therefore, it is effective to use an antifoaming agent.

Examples of a usable antifoaming agent can include silicone-based or fluorosilicone-based emulsion type, self-emulsifying type, oil type, oil compound type, solution type, powder type, and solid type antifoaming agents, but the antifoaming agent may be appropriately selected in combination with a solvent to be used. In particular, in order to make the antifoaming agent be present at an interface between a solvent and air rather than at an interface between a solvent used as a non-aqueous organic solvent and a fluororesin particle, for example, a hydrophilic or water-soluble silicone foaming agent is preferably used, but it is not particularly limited thereto. A content of the antifoaming agent in a dispersion of a fluoroethylene particle may be changed by a content (concentration) of a dispersion of the fluororesin particle or the like, but the content of the antifoaming agent is preferably 1% by mass or less with respect to a total mass of the dispersion.

Electrophotographic Photosensitive Member

Next, a configuration of the electrophotographic photosensitive member according to the present invention will be described.

The electrophotographic photosensitive member includes a support, a photosensitive layer provided on the support, and a surface layer provided on the photosensitive layer. In addition, the electrophotographic photosensitive member may include an electro-conductive layer or an undercoat layer between the support and the photosensitive layer.

An example of a method of forming each layer can include a method in which coating liquids for layers to be described later are prepared and applied onto the layers in a desired order, and the layers are dried. In this case, examples of a method of applying a coating liquid can include dip coating, spray coating, ink jet coating, roll coating, die coating, blade coating, curtain coating, wire bar coating, and ring coating. Among them, dip coating is preferable from the viewpoints of efficiency and productivity.

<Support>

In the present invention, the support is preferably an electro-conductive support having electro-conductivity. In addition, examples of a shape of the support can include a cylindrical shape, a belt shape, and a sheet shape. Among them, a cylindrical support is preferable. In addition, a surface of the support may be subjected to an electrochemical treatment such as anodization, a blast treatment, or a cutting treatment.

As a material for the support, a metal, a resin, or glass is preferable.

Examples of the metal can include aluminum, iron, nickel, copper, gold, and stainless steel, or alloys thereof. Among them, an aluminum support obtained by using aluminum is preferable.

In addition, electro-conductivity may be imparted to the resin or glass through a treatment such as mixing or coating the resin or glass with an electro-conductive material.

<Electro-Conductive Layer>

In the present invention, an electro-conductive layer may be provided on the support. By providing the electro-conductive layer, scratches or unevenness on the surface of the support can be concealed, or reflection of light on the surface of the support can be controlled.

The electro-conductive layer preferably contains an electro-conductive particle and a resin.

Examples of a material for the electro-conductive particle can include a metal oxide, a metal, and carbon black.

Examples of the metal oxide can include zinc oxide, aluminum oxide, indium oxide, silicon oxide, zirconium oxide, tin oxide, titanium oxide, magnesium oxide, antimony oxide, and bismuth oxide. Examples of the metal can include aluminum, nickel, iron, nichrome, copper, zinc, and silver.

Among them, the metal oxide is preferably used for the electro-conductive particle. In particular, titanium oxide, tin oxide, or zinc oxide is more preferably used for the electro-conductive particle.

In a case where the metal oxide is used for the electro-conductive particle, a surface of the metal oxide may be treated with a silane coupling agent or the like, or the metal oxide may be doped with an element such as phosphorus or aluminum, or an oxide thereof.

In addition, the electro-conductive particle may have a laminate structure having a core particle and a covering layer that covers the core particle. Examples of a material of the core particle can include titanium oxide, barium sulfate, and zinc oxide. Examples of a material for the covering layer can include a metal oxide such as tin oxide.

In addition, in a case where the metal oxide is used for the electro-conductive particle, a volume average particle diameter thereof is preferably 1 nm or more and 500 nm or less, and more preferably 3 nm or more and 400 nm or less.

Examples of the resin can include a polyester resin, a polycarbonate resin, a polyvinyl acetal resin, an acrylic resin, a silicone resin, an epoxy resin, a melamine resin, a polyurethane resin, a phenol resin, and an alkyd resin.

In addition, the electro-conductive layer may further contain a masking agent such as silicone oil, a resin particle, or titanium oxide.

An average thickness of the electro-conductive layer is preferably 1 μm or more and 50 μm or less, and particularly preferably 3 μm or more and 40 μm or less.

The electro-conductive layer can be formed by preparing a coating liquid for an electro-conductive layer containing the above-described respective materials and a solvent, forming a coating film of the coating liquid for an electro-conductive layer, and drying the coating film. Examples of the solvent used in the coating liquid for an electro-conductive layer can include an alcohol-based solvent, a sulfoxide-based solvent, a ketone-based solvent, an ether-based solvent, an ester-based solvent, and an aromatic hydrocarbon-based solvent. Examples of a method for dispersing the electro-conductive particles in the coating liquid for an electro-conductive layer can include methods using a paint shaker, a sand mill, a ball mill, and a liquid collision-type high-speed disperser.

<Undercoat Layer>

In the present invention, an undercoat layer may be provided on the support or the electro-conductive layer. By providing the undercoat layer, an adhesive function between layers can be increased to impart a charge injection inhibiting function.

The undercoat layer preferably contains a resin. In addition, the undercoat layer may be formed as a cured film by polymerizing a composition containing a monomer having a polymerizable functional group.

Examples of the resin can include a polyester resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamide acid resin, a polyimide resin, a polyamide imide resin, and a cellulose resin.

Examples of the polymerizable functional group included in the monomer having the polymerizable functional group can include an isocyanate group, a block isocyanate group, a methylol group, an alkylated methylol group, an epoxy group, a metal alkoxide group, a hydroxyl group, an amino group, a carboxyl group, a thiol group, a carboxylic acid anhydride group, and a carbon-carbon double bond group.

In addition, the undercoat layer may further contain an electron transporting substance, a metal oxide, a metal, an electro-conductive polymer, and the like, in order to improve electric characteristics. Among them, an electron transporting substance or a metal oxide may be preferably used.

Examples of the electron transporting substance can include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound. An electron transporting substance having a polymerizable functional group may be used as the electron transporting substance and copolymerized with the above-described monomer having the polymerizable functional group to form an undercoat layer as a cured film.

Examples of the metal oxide can include indium tin oxide, tin oxide, indium oxide, titanium oxide, zinc oxide, aluminum oxide, and silicon dioxide. Examples of the metal can include gold, silver, and aluminum.

In addition, the undercoat layer may further contain an additive.

An average thickness of the undercoat layer is preferably 0.1 μm or more and 50 μm or less, more preferably 0.2 μm or more and 40 μm or less, and particularly preferably 0.3 μm or more and 30 μm or less.

The undercoat layer can be formed by preparing a coating liquid for an undercoat layer containing the above-described respective materials and a solvent, forming a coating film of the coating liquid for an undercoat layer, and drying and/or curing the coating film. Examples of the solvent used in the coating liquid can include an alcohol-based solvent, a ketone-based solvent, an ether-based solvent, an ester-based solvent, and an aromatic hydrocarbon-based solvent.

<Photosensitive Layer>

A photosensitive layer of the electrophotographic photosensitive member is mainly classified into (1) a laminate type photosensitive layer and (2) a monolayer type photosensitive layer. (1) The laminate type photosensitive layer has a charge generation layer containing a charge generating substance and a charge transport layer containing a charge transporting substance. (2) The monolayer type photosensitive layer has a photosensitive layer containing both a charge generating substance and a charge transporting substance.

(1) Laminate Type Photosensitive Layer

The laminate type photosensitive layer has a charge generation layer and a charge transport layer.

(1-1) Charge Generation Layer

The charge generation layer preferably contains a charge generating substance and a resin.

Examples of the charge generating substance can include an azo pigment, a perylene pigment, a polycyclic quinone pigment, an indigo pigment, and a phthalocyanine pigment. Among them, an azo pigment or a phthalocyanine pigment is preferable. Among the phthalocyanine pigments, an oxytitanium phthalocyanine pigment, a chlorogallium phthalocyanine pigment, or a hydroxygallium phthalocyanine pigment is preferable.

A content of the charge generating substance in the charge generation layer is preferably 40% by mass or more and 85% by mass or less, and more preferably 60% by mass or more and 80% by mass or less, with respect to a total mass of the charge generation layer.

Examples of the resin can include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin, and a polyvinyl chloride resin. Among them, a polyvinyl butyral resin is more preferable.

In addition, the charge generation layer may further contain an additive such as an antioxidant or an ultraviolet absorber. Specific examples thereof can include a hindered phenol compound, a hindered amine compound, a sulfur compound, a phosphorus compound, and a benzophenone compound.

An average thickness of the charge generation layer is preferably 0.1 μm or more and 1 μm or less, and more preferably 0.15 μm or more and 0.4 μm or less.

The charge generation layer can be formed by preparing a coating liquid for a charge generation layer containing the above-described respective materials and a solvent, forming a coating film of the coating liquid for a charge generation layer, and drying the coating film. Examples of the solvent used in the coating liquid for a charge generation layer can include an alcohol-based solvent, a sulfoxide-based solvent, a ketone-based solvent, an ether-based solvent, an ester-based solvent, and an aromatic hydrocarbon-based solvent.

(1-2) Charge Transport Layer

The charge transport layer preferably contains a charge transporting substance and a resin.

Examples of the charge transporting substance can include a polycyclic aromatic compound, a heterocyclic compound, a hydrazone compound, a styryl compound, an enamine compound, a benzidine compound, a triarylamine compound, and a resin having a group derived from these substances. Among them, a triarylamine compound or a benzidine compound is preferable.

A content of the charge transporting substance in the charge transport layer is preferably 25% by mass or more and 70% by mass or less, and more preferably 30% by mass or more and 55% by mass or less, with respect to a total mass of the charge transport layer.

Examples of the resin can include a polyester resin, a polycarbonate resin, an acrylic resin, and a polystyrene resin. Among them, a polycarbonate resin or a polyester resin is preferable. As the polyester resin, a polyarylate resin is particularly preferable.

A content ratio (mass ratio) of the charge transporting substance to the resin is preferably 4:10 to 20:10 and more preferably 5:10 to 12:10.

In addition, the charge transport layer may also contain additives such as an antioxidant, an ultraviolet absorber, a plasticizer, a leveling agent, a lubricity imparting agent, and an abrasion resistance improver. Specific examples thereof can include a hindered phenol compound, a hindered amine compound, a sulfur compound, a phosphorus compound, a benzophenone compound, a siloxane-modified resin, silicone oil, a fluororesin particle, a polystyrene resin particle, a polyethylene resin particle, a silica particle, an alumina particle, and a boron nitride particle.

An average thickness of the charge transport layer is preferably 5 μm or more and 50 μm or less, more preferably 8 μm or more and 40 μm or less, and particularly preferably 10 μm or more and 30 μm or less.

The charge transport layer can be formed by preparing a coating liquid for a charge transport layer containing the above-described respective materials and a solvent, forming a coating film of the coating liquid for a charge transport layer, and drying the coating film. Examples of the solvent used in the coating liquid can include an alcohol-based solvent, a ketone-based solvent, an ether-based solvent, an ester-based solvent, and an aromatic hydrocarbon-based solvent. Among these solvents, an ether-based solvent or an aromatic hydrocarbon-based solvent is preferable.

(2) Monolayer Type Photosensitive Layer

The monolayer type photosensitive layer can be formed by preparing a coating liquid for a photosensitive layer containing a charge generating substance, a charge transporting substance, a resin, and a solvent, forming a coating film of the coating liquid for a photosensitive layer, and drying the coating film. Examples of materials of the charge generating substance, the charge transporting substance, and the resin are the same as in the “(1) Laminate Type Photosensitive Layer”.

<Surface Layer>

The electrophotographic photosensitive member according to the present invention includes a surface layer provided on the photosensitive layer. The surface layer is a cured surface layer containing a curable resin. The cured surface layer contains a cured product of a composition containing a charge transporting substance having a polymerizable functional group, a compound represented by Formula (1), a fluororesin particle, and polyvinyl acetal. Light, heat, or radiation (electron beam or the like) can be used to cure the composition.

As the solvent used for the coating liquid for a surface layer containing the composition, solvents that do not dissolve a lower layer of the surface layer to be formed are preferably used alone or in a mixture thereof. In addition, the solvent is not particularly limited as long as it is a solvent that dissolves the charge transporting substance, the compound represented by Formula (1), and the polyvinyl acetal that are contained in the surface layer at desired concentrations. Examples of the solvent can include an alcohol-based solvent, an ester-based solvent, an ether-based solvent, a ketone-based solvent, a fluorine atom-containing solvent, and a mixture thereof.

When the coating liquid for a surface layer is applied, for example, an application method such as a dip coating method, a spray coating method, a spin coating method, a roller coating method, a wire bar coating method, or a blade coating method can be used.

A thickness of the surface layer is preferably 0.5 μm or more and 10 μm or less, and more preferably 1 μm or more and 7 μm or less.

In addition, the surface layer may also contain additives such as an antioxidant, an ultraviolet absorber, a plasticizer, a leveling agent, a lubricity imparting agent, and an abrasion resistance improver. Specific examples thereof can include a hindered phenol compound, a hindered amine compound, a sulfur compound, a phosphorus compound, a benzophenone compound, a siloxane-modified resin, silicone oil, a polystyrene resin particle, a polyethylene resin particle, a silica particle, an alumina particle, and a boron nitride particle.

In addition, a concave or convex shape may be imparted to the surface of the surface layer (the surface of the electrophotographic photosensitive member) in order to improve stability of a cleaning blade.

Process Cartridge and Electrophotographic Apparatus

A process cartridge according to the present invention integrally supports the electrophotographic photosensitive member described above and at least one unit selected from the group consisting of a charging unit, a developing unit, and a cleaning unit, and is detachably attachable to a main body of an electrophotographic apparatus.

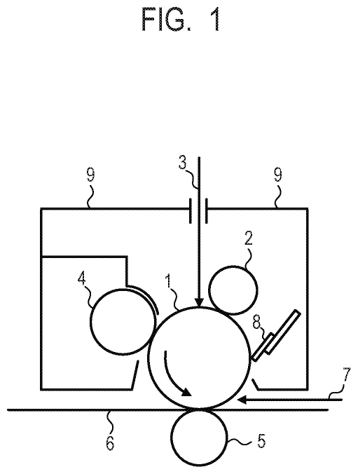

FIG. 1 illustrates an example of a configuration of the process cartridge according to the present invention. In FIG. 1, a cylindrical electrophotographic photosensitive member 1 is rotatably driven in the arrow direction at a predetermined peripheral velocity. A circumferential surface of the electrophotographic photosensitive member 1 rotatably driven is evenly charged to have a predetermined positive or negative potential by a charging unit 2. Subsequently, the charged circumferential surface of the electrophotographic photosensitive member 1 is irradiated with exposure light (image exposure light) 3 emitted from an exposing unit (not illustrated), such as slit exposure light or laser beam scanning exposure light. Thus, electrostatic latent images corresponding to target images are sequentially formed on the circumferential surface of the electrophotographic photosensitive member 1. Any one of a voltage obtained by superimposing an alternating current component on a direct current component and a voltage consisting of only a direct current component may be used as a voltage to be applied to the charging unit (charging roller or the like) 2.

The electrostatic latent image formed on the circumferential surface of the electrophotographic photosensitive member 1 is used as a toner image developed by a toner contained in a developer of a developing unit 4. Subsequently, the toner images formed and carried on the circumferential surface of the electrophotographic photosensitive member 1 are sequentially transferred onto a transfer material (paper, intermediate transfer member, or the like) 6 by a transfer bias from a transfer unit (transfer roller or the like) 5. The transfer material 6 is fed in synchronization with the rotation of the electrophotographic photosensitive member 1.

A surface of the electrophotographic photosensitive member 1 after the toner image transfer is subjected to an antistatic treatment by pre-exposure light 7 emitted from a pre-exposing unit (not illustrated), and then the treated surface is cleaned through a removal of a transfer residual toner by a cleaning unit 8. Then, the electrophotographic photosensitive member 1 is repeatedly used in image formation. The pre-exposing unit may be used before or after the cleaning step, and the pre-exposing unit is not necessarily used.

The electrophotographic photosensitive member 1 may be mounted on an electrophotographic apparatus such as a copying machine or a laser beam printer. In addition, a process cartridge 9 storing and integrally supporting a plurality of components such as the electrophotographic photosensitive member 1, the charging unit 2, the developing unit 4, and the cleaning unit 8 may be detachably attachable to the main body of the electrophotographic apparatus. FIG. 1 illustrates the process cartridge 9 integrally supporting the electrophotographic photosensitive member 1, the charging unit 2, the developing unit 4, and the cleaning unit 8 and detachably attachable to the main body of the electrophotographic apparatus.

In addition, an electrophotographic apparatus according to the present invention includes the electrophotographic photosensitive member described above, a charging unit, an exposing unit, a developing unit, and a transfer unit.

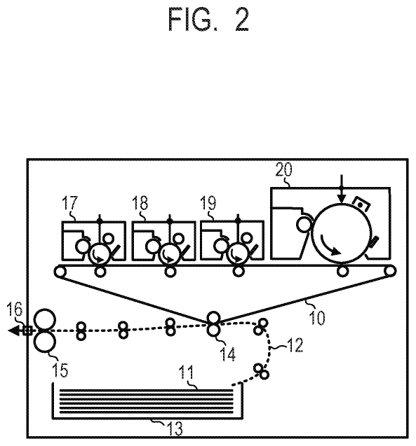

FIG. 2 illustrates an example of a configuration of the electrophotographic apparatus according to the present invention. A process cartridge 17 for a yellow color, a process cartridge 18 for a magenta color, a process cartridge 19 for a cyan color, and a process cartridge 20 for a black color are arranged along an intermediate transfer member 10. As illustrated in FIG. 2, a diameter and constituent materials of an electrophotographic photosensitive member, a developer, a charging method, and other units do not necessarily need to be standardized for the respective colors. For example, in the electrophotographic apparatus of FIG. 2, the diameter of the electrophotographic photosensitive member of the process cartridge for the black color is larger than the diameters of the electrophotographic photosensitive members of the process cartridges for the colors (yellow, magenta, and cyan). In addition, a method of applying the voltage obtained by superimposing the alternating current component on the direct current component is adopted as a method of charging the colors, whereas a method using a corona charging is adopted for the black color.

When an image forming operation starts, the toner images of the respective colors are sequentially superimposed on the intermediate transfer member 10 according to the image forming process. At the same time, a transfer paper 11 is fed from a paper feed tray 13 by a paper feed path 12 and is fed to a secondary transfer unit 14 in the same timing as that of a rotational operation of the intermediate transfer member 10. The toner image formed on the intermediate transfer member 10 is transferred onto the transfer paper 11 by a transfer bias from the secondary transfer unit 14. The toner image transferred onto the transfer paper 11 is conveyed along the paper feed path 12, is fixed onto the transfer paper by a fixing unit 15, and is discharged from a paper discharge portion 16.

### EXAMPLES

Hereinafter, the present invention will be described in more detail with reference to specific examples. However, the present invention is not limited to these examples. The “parts” and “%” in the examples refer to “parts by mass” and “% by mass”, respectively.

### Example 1

An aluminum cylinder having a diameter of 30 mm, a length of 357.5 mm, and a thickness of 1 mm was prepared as a support (electro-conductive support).

Next, 100 parts of a zinc oxide particle (specific surface area: 19 m²/g, powder resistivity: 4.7×10⁶ Ω·cm) and 500 parts of toluene were stirred and mixed with each other. 0.8 parts of a silane coupling agent (trade name: KBM-602, manufactured by Shin-Etsu Chemical Co., Ltd., compound name: N-2-(aminoethyl)-3-aminopropylmethyldimethoxysilane) were added thereto, and the mixture was stirred for 6 hours. Thereafter, the toluene was removed by distillation under a reduced pressure, and heat-drying was performed at 130° C. for 6 hours, thereby obtaining a surface-treated zinc oxide particle.

Next, the following materials were prepared.
15 parts of polyvinyl butyral (trade name: BM-1, manufactured by SEKISUI CHEMICAL CO., LTD., weight average molecular weight: 40,000)
15 parts of blocked isocyanate (trade name: DURANATE TPA-B80E, manufactured by Asahi Kasei Chemicals Corporation)

These materials were dissolved in a solvent obtained by mixing 73.5 parts of methyl ethyl ketone with 73.5 parts of 1-butanol. 80.8 parts of the surface-treated zinc oxide particle and 0.4 parts of 2,3,4-trihydroxybenzophenone (manufactured by Tokyo Chemical Industry Co., Ltd.) were added to the dissolved solution. The mixture was added to a sand mill using a glass bead having a diameter of 0.8 mm and was subjected to a dispersion treatment under an atmosphere of 23±3° C. for 3 hours.

After the dispersion treatment, the following materials were prepared.
0.01 parts of silicone oil (trade name: SH28PA, manufactured by Dow Corning Toray Co., Ltd.)
5.6 parts of crosslinked polymethyl methacrylate (PMMA) particle (trade name: TECHPOLYMER SSX-103, manufactured by SEKISUI PLASTICS CO., LTD., average primary particle diameter: 3 μm)

These materials were added to the solvent subjected to the dispersion treatment and the mixture was stirred to prepare a coating liquid for an undercoat layer.

The coating liquid for an undercoat layer was dipped and applied onto the support to form a coating film, and the obtained coating film was dried at 160° C. for 40 minutes, thereby forming an undercoat layer having a thickness of 18 μm.

Next, the following materials were prepared.
4 parts of hydroxy gallium phthalocyanine crystal (charge generating substance) in crystal form with intensive peaks at Bragg angles (2θ±0.2°) of 7.4° and 28.1° in CuKα characteristic X-ray diffraction
0.04 parts of compound represented by the following Formula (A)

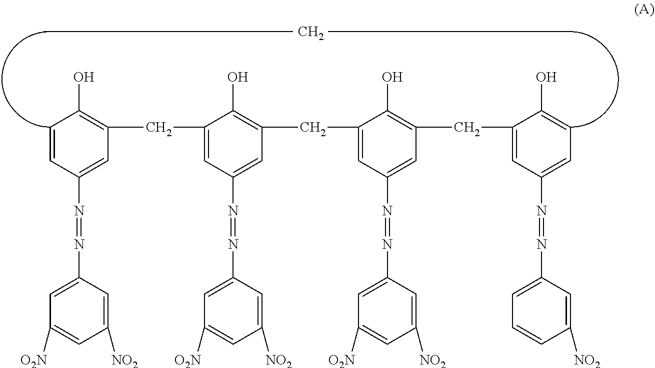

These materials were added to a solution obtained by dissolving 2 parts of polyvinyl butyral (trade name: S-LEC BX-1, manufactured by SEKISUI CHEMICAL CO., LTD.) in 100 parts of cyclohexanone. The obtained solution was added to a sand mill using a glass bead having a diameter of 1 mm and was subjected to a dispersion treatment under an atmosphere of 23±3° C. for 1 hour.

A coating liquid for a charge generation layer was prepared by adding 100 parts of ethyl acetate to the solution subjected to the dispersion treatment.

The coating liquid for a charge generation layer was dipped and applied onto the undercoat layer to form a coating film, and the obtained coating film was dried at 90° C. for 10 minutes, thereby forming a charge generation layer having a thickness of 0.19 μm.

Next, the following materials were prepared.
60 parts of compound represented by the following Formula (B) (charge transporting sub stance)
30 parts of compound represented by the following Formula (C) (charge transporting sub stance)
10 parts of compound represented by the following Formula (D) (charge transporting substance)

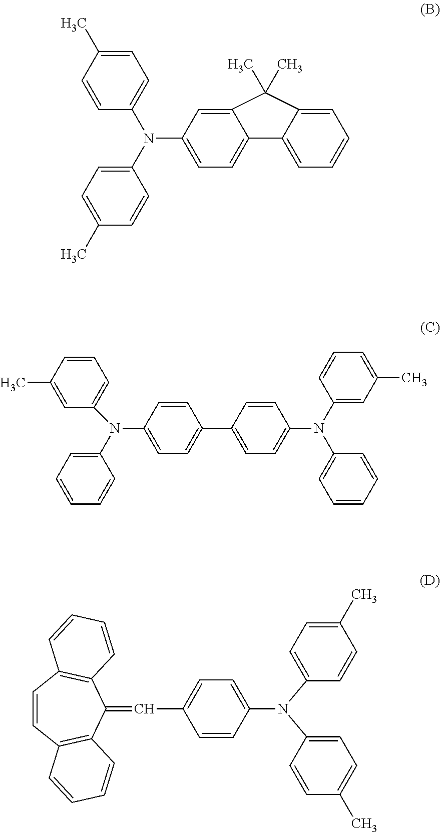

100 parts of polycarbonate (trade name: Iupilon Z400, manufactured by Mitsubishi Engineering-Plastics Corporation, bisphenol Z type polycarbonate)
0.2 parts of polycarbonate having structural unit represented by the following Formula (E) (viscosity average molecular weight Mv: 20,000)

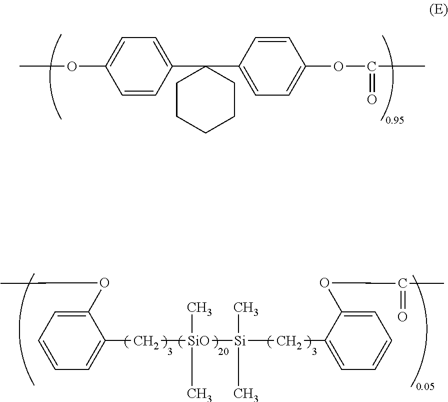

These materials were dissolved in a solvent obtained by mixing 260 parts of o-xylene, 240 parts of methyl benzoate, and 260 parts of dimethoxymethane with each other, thereby preparing a coating liquid for a charge transport layer.

The coating liquid for a charge transport layer was dipped and applied onto the charge generation layer to form a coating film, and the obtained coating film was dried at 120° C. for 60 minutes, thereby forming a charge transport layer having a thickness of 18 μm.

Preparation of Polytetrafluoroethylene Particle Dispersion for Surface Layer

The S-LEC BL-10 (manufactured by SEKISUI CHEMICAL CO., LTD., amount of hydroxyl group: 28 mol %, butyralization degree: 71±3 mol %, molecular weight: about 15,000) was used as the polyvinyl acetal. In addition, a polytetrafluoroethylene particle having an average particle diameter of 0.2 μm was used as the fluororesin particle. 1.2 parts of the S-LEC BL-10 were sufficiently stirred and dissolved in a solvent obtained by mixing 48.8 parts of isopropanol with 20 parts of 1-butanol, 30 parts of the polytetrafluoroethylene particle was added thereto, and the mixture was stirred and mixed, thereby obtaining a mixed solution. The polytetrafluoroethylene particles were dispersed with a zirconia bead having a diameter of 0.3 mm using a bead mill, 0.1 parts of a silicone antifoaming agent KM-72 (manufactured by Shin-Etsu Silicones) was added, and the mixture was stirred, thereby obtaining a polytetrafluoroethylene particle dispersion for a surface layer.

Step of Preparing Coating Liquid for Surface Layer

Subsequently, the following materials were prepared.
55 parts of hole transport compound represented by Formula (H-19)
20 parts of compound represented by Formula (1-3)
50 parts of 1,1,2,2,3,3,4-heptafluorocyclopentane
50 parts of 1-propanol

These materials were added to the prepared polytetrafluoroethylene particle dispersion for a surface layer, and the mixture was stirred, thereby obtaining a mixed solution. Then, the obtained mixed solution was filtered by a POLYFLON filter (trade name: PF-040, manufactured by Advantec Toyo Kaisha, Ltd.), thereby preparing a coating liquid for a surface layer.

Step of Forming Surface Layer

The coating liquid for a surface layer obtained as described above was dipped and applied onto the charge transport layer to obtain a coating film, the obtained coating film was dried at 50° C. for 10 minutes, and the coating film was subjected to electron beam irradiation and a polymerization curing treatment by heating under the following conditions.

The electron irradiation was performed under an atmosphere of an oxygen concentration of 50 ppm or less and was performed under conditions of an irradiation distance of 30 mm, an acceleration voltage of 70 kV, a beam current of 8 mA, and an irradiation time of 3.0 seconds using an electron beam irradiation device, while rotating the support at a speed of 300 rpm. After the electron beam irradiation, a surface of the coating film of the coating liquid for a surface layer was rapidly heated to 135° C. for 24 seconds using an induction heating device under the same condition of the oxygen concentration of 50 ppm or less.

Next, a precursor of the electrophotographic photosensitive member was taken out to the atmosphere and further heated at 100° C. for 12 minutes, thereby forming a surface layer having a thickness of 5 μm.

Step of Surface-Processing Electrophotographic Photosensitive Member

Next, a mold member (mold) was installed in a press-contact shape transfer processing device to perform surface-processing of the produced electrophotographic photosensitive member.

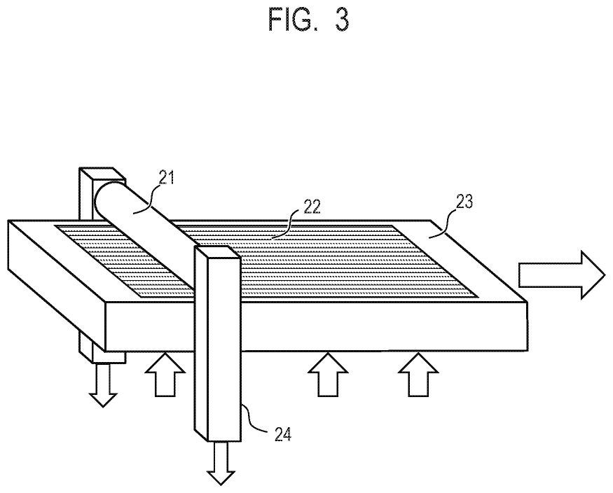

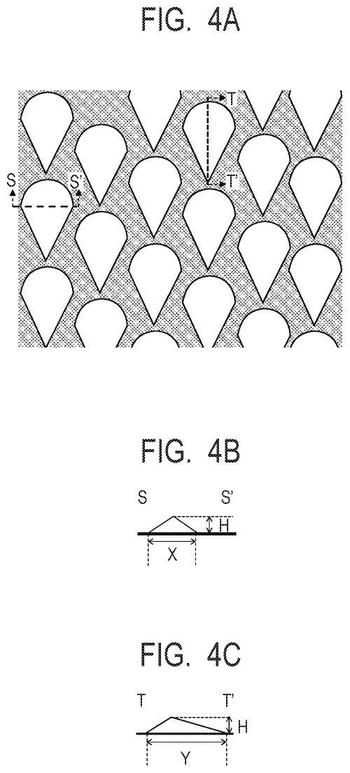

Specifically, a mold having a shape and an arrangement of concave portions as illustrated in FIG. 4A to FIG. 4C was installed in the press-contact shape transfer processing device having a mold 22, a pressurizing member 23, and a support member generally illustrated in FIG. 3 to perform surface-processing of an electrophotographic photosensitive member 21. FIG. 4A to FIG. 4C are views illustrating the shape and the arrangement of the convex portions of the mold used in examples and comparative examples. FIG. 4A is a top view illustrating the arrangement of the convex portions of the mold. FIG. 4B is a cross-sectional view (cross-sectional view in S-S′ section of FIG. 4A) of the convex portion of the mold in an axial direction of the electrophotographic photosensitive member 21. FIG. 4C is a cross-sectional view (cross-sectional view in T-T′ section of FIG. 4A) of the convex portion of the mold in a circumferential direction of the electrophotographic photosensitive member 21.

The mold illustrated in each of FIG. 4A to FIG. 4C has a convex portion having a maximum width X of 50 μm, a maximum length Y of 75 μm, an area ratio of 56%, and a height H of 4 μm. Here, the maximum width refers to a maximum width in the axial direction of the electrophotographic photosensitive member 21 when the convex portion formed on the mold is viewed from above. In addition, the maximum length refers to a maximum length in the circumferential direction of the electrophotographic photosensitive member 21 when the convex portion formed on the mold is viewed from above. The area ratio is a ratio of areas of the convex portions occupying the entire surface when the mold is viewed from above.

At the time of processing, a temperature of each of the electrophotographic photosensitive member 21 and the mold was controlled so that the temperature of a surface of the electrophotographic photosensitive member 21 was 120° C. Then, the electrophotographic photosensitive member 21 was rotated in the circumferential direction while pressing the electrophotographic photosensitive member and the pressurizing member against the mold at a pressure of 7.0 MPa to form a concave portion on the entire surface layer (circumferential surface) of the electrophotographic photosensitive member 21.

The resulting surface of the electrophotographic photosensitive member 21 was magnified and observed by a lens with a magnification of 50 with a laser microscope (trade name: X-100, manufactured by KEYENCE CORPORATION) to observe the concave portion formed on the surface of the electrophotographic photosensitive member. At the time of observation, an adjustment was performed so that there was no inclination in a longitudinal direction of the electrophotographic photosensitive member or so that the lens was focused on a vertex of an arc of the electrophotographic photosensitive member in the circumferential direction. The magnified and observed images were connected to each other by an image connecting application to obtain a square region of 500 μm×500 μm. Then, the obtained resultant was subjected to filter processing with a filter type median by selecting image processing height data by an attached image analysis software.

As a result of the observation, a depth of the concave portion was 2 μm, a width in an axial direction of an opening of the concave portion was 50 μm, a length in a circumferential direction of the opening was 75 μm, and an area of the concave portion was 140,000 μm². The area is an area of the concave portion when the surface of the electrophotographic photosensitive member is viewed from above. The area refers to an area of the opening of the concave portion.

As described above, the electrophotographic photosensitive member according to Example 1 was produced.

### Example 2

In the preparation of the polytetrafluoroethylene particle dispersion for a surface layer of Example 1, polyvinyl acetal to be used was changed. Specifically, the S-LEC BM-1 (polyvinyl acetal, manufactured by SEKISUI CHEMICAL CO., LTD., amount of hydroxyl group: 34 mol %, butyralization degree: 65±3 mol %, molecular weight: 40,000) was used instead of the S-LEC BL-10. Except for this, an electrophotographic photosensitive member according to Example 2 was produced in the same manner as that of Example 1.

### Example 3

In the step of preparing the coating liquid for a surface layer of Example 1, a hole transport compound represented by Formula (H-16) was used instead of the hole transport compound represented by Formula (H-19). Except for this, an electrophotographic photosensitive member according to Example 3 was produced in the same manner as that of Example 1.

### Example 4

In the step of preparing the coating liquid for a surface layer of Example 1, a polymerizable compound represented by Formula (1-4) was used instead of the polymerizable compound represented by Formula (1-3). Except for this, an electrophotographic photosensitive member according to Example 4 was produced in the same manner as that of Example 1.

### Example 5

In the step of preparing the coating liquid for a surface layer of Example 1, a polymerizable compound represented by Formula (1-1) was used instead of the polymerizable compound represented by Formula (1-3). Except for this, an electrophotographic photosensitive member according to Example 5 was produced in the same manner as that of Example 1.

### Example 6

In the step of preparing the coating liquid for a surface layer of Example 2, a polymerizable compound represented by Formula (1-1) was used instead of the polymerizable compound represented by Formula (1-3). Except for this, an electrophotographic photosensitive member according to Example 6 was produced in the same manner as that of Example 2.

### Example 7

In the step of preparing the coating liquid for a surface layer of Example 5, a hole transport compound represented by Formula (H-5) was used instead of the hole transport compound represented by Formula (H-19). Except for this, an electrophotographic photosensitive member according to Example 7 was produced in the same manner as that of Example 5.

### Example 8

In the step of preparing the coating liquid for a surface layer of Example 6, a hole transport compound represented by Formula (H-5) was used instead of the hole transport compound represented by Formula (H-19). Except for this, an electrophotographic photosensitive member according to Example 8 was produced in the same manner as that of Example 6.

### Examples 9 to 13

In the preparation of the polytetrafluoroethylene particle dispersion for a surface layer of Example 7, the amount of each S-LEC BL-10 used as the polyvinyl acetal was changed as shown in Table 1. Except for this, each of electrophotographic photosensitive members according to Examples 9 to 13 was produced in the same manner as that of Example 7.

### Example 14

In the step of preparing the coating liquid for a surface layer of Example 8, the amounts of the following materials used were changed as follows.
Polymerizable compound represented by Formula (1-1): 30 parts
1,1,2,2,3,3,4-Heptafluorocyclopentane: 60 parts
1-Propanol: 90 parts
Polytetrafluoroethylene particle dispersion for surface layer: 66.7 parts

Except for this, an electrophotographic photosensitive member according to Example 14 was produced in the same manner as that of Example 8.

### Example 15

In the step of preparing the coating liquid for a surface layer of Example 8, the amounts of the following materials used were changed as follows.
Hole transport compound represented by Formula (H-5): 65 parts
Polymerizable compound represented by Formula (1-1): 30 parts
1,1,2,2,3,3,4-Heptafluorocyclopentane: 70 parts
1-Propanol: 140 parts
Polytetrafluoroethylene particle dispersion for surface layer: 33.4 parts

Except for this, an electrophotographic photosensitive member according to Example 15 was produced in the same manner as that of Example 8.

### Examples 16 to 19

In the step of preparing the coating liquid for a surface layer of Example 7, the amount of the used hole transport compound represented by Formula (H-5) and the amount of the used hole transport compound represented by Formula (1-1) were changed as shown in Table 1. Except for this, each of electrophotographic photosensitive members according to Examples 16 to 19 was produced in the same manner as that of Example 7.

### Example 20

In the step of preparing the coating liquid for a surface layer of Example 19, a hole transport compound represented by Formula (H-15) was used instead of the hole transport compound represented by Formula (H-5). Except for this, an electrophotographic photosensitive member according to Example 20 was produced in the same manner as that of Example 19.

### Examples 21 to 24

In the preparation of the polytetrafluoroethylene particle dispersion for a surface layer of Example 19, the amount of each S-LEC BL-10 used as the polyvinyl acetal was changed as shown in Table 1. Except for this, each of electrophotographic photosensitive members according to Examples 21 to 24 was produced in the same manner as that of Example 19.

### Comparative Examples 1 and 2

In the step of preparing the coating liquid for a surface layer of Example 19, Comparative Compound No. 1 represented by the following formula in Comparative Example 1 and Comparative Compound No. 2 represented by the following formula in Comparative Example 2 were used instead of the polymerizable compound represented by Formula (1-1). Except for this, each of electrophotographic photosensitive members according to Comparative Examples 1 and 2 was produced in the same manner as that of Example 19.

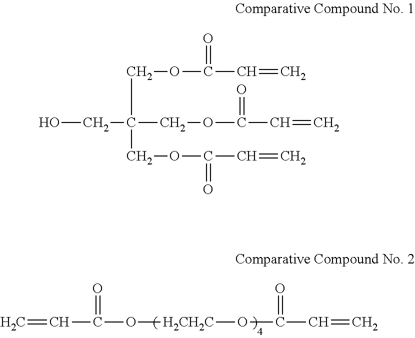

### Comparative Example 3

In the preparation of the polytetrafluoroethylene particle dispersion for a surface layer of Example 20, a fluorine surfactant (trade name: FTERGENT DFX-18, manufactured by Neos Corporation) was used instead of the S-LEC BL-10 as polyvinyl acetal. Except for this, an electrophotographic photosensitive member according to Comparative Example 3 was produced in the same manner as that of Example 20.

<Evaluation: Potential Fluctuation During Repeated Paper Feed>

A modified copying machine (trade name: iR-ADVC5051) was used as the electrophotographic apparatus for evaluation.

First, the electrophotographic apparatus and the electrophotographic photosensitive member were left under a room temperature and low humidity environment of temperature of 23° C. and humidity of 5% RH for 48 hours, and then each of the electrophotographic photosensitive members according to the examples and the comparative examples was mounted in a black station of the electrophotographic apparatus.

A surface potential of the electrophotographic photosensitive member was measured by removing the cartridge for development from an evaluation device and inserting a potential measuring device into a position thereof. In the potential measuring device, potential measuring probes are arranged at a development position of the cartridge for development. The potential measuring probes with respect to the electrophotographic photosensitive member were positioned at the center of a generatrix direction of the electrophotographic photosensitive member. A gap from the surface of the electrophotographic photosensitive member was 3 mm.

In the measurement of the potential, first, an application voltage was adjusted so that an initial dark part potential (VDa) was −850 V, and an image exposure amount was adjusted so that an initial light part potential (VLa) was −200 V. The same operations were performed for each electrophotographic photosensitive member to be evaluated.

Subsequently, the cartridge for development was attached to the evaluation device, and then 10,000 sheets of images were output. After the 10,000 sheets of the images were output, the cartridge for development was replaced with the potential measuring device, and then a light part potential (VLb) after repeated use was measured.

Then, a fluctuation amount between the initial light part potential (VLa) before the paper feed and the light part potential (VLb) after the paper feed was confirmed, and then the value thereof was defined as a light part potential fluctuation ΔVL. The results are shown in Table 1.

<Evaluation: Image Definition (Fine Line Reproducibility)>

A modified copying machine (trade name: iR-ADVC5051) was used as the electrophotographic apparatus for evaluation.

First, the electrophotographic apparatus and the electrophotographic photosensitive member were left under a room temperature and low humidity environment of temperature of 23° C. and humidity of 5% RH for 48 hours, and then each of the electrophotographic photosensitive members according to the examples and the comparative examples was mounted in a cyan station of the electrophotographic apparatus.

Next, the conditions of a charging device and an image exposing device were set so that a dark part potential (VD) of the electrophotographic photosensitive member was −700 V and a light part potential (VL) of the electrophotographic photosensitive member was −200 V to adjust an initial potential of the electrophotographic photosensitive member.

A fine line reproducibility was evaluated by adjusting an image contrast so that a concentration thereof was 1.40±0.10. A test chart was created by arranging line images (1 line and 3 spaces on A4 vertical size paper) at an output resolution of 1,200 dpi. The fine line reproducibility of the electrophotographic photosensitive member was evaluated by the image on which the test chart was output. Specifically, the output image was read at a resolution of 1,600 dpi using a scanner (trade name: CanoScan9900F, manufactured by Canon Inc.), and then the read image data and the original data of the test chart were compared with each other. The read image data was extracted from the line of the test chart (original data), an area of a deviation portion was calculated, and then the fine line reproducibility of the electrophotographic photosensitive member was evaluated by a value thereof. The obtained result was ranked based on the following criteria. The results are shown in Table 1. It should be noted that the cleanability was excellent in all of the examples.

A: Clear image very excellent in fine line reproducibility

B: Clear image excellent in fine line reproducibility

C: Good image in spite of slightly degraded fine line reproducibility and image uniformity

D: Image having degraded fine line reproducibility but having no problem in practical use

E: Image having significantly degraded fine line reproducibility

<Evaluation: Image Deletion Evaluation Under High Temperature and High Humidity Environment>

A modified copying machine (trade name: iR-ADVC5560, manufactured by Canon Inc.) was used as the electrophotographic apparatus for evaluation. As the modification points, the image exposure amount, the amount of current flowing from the charging roller to the support of the electrophotographic photosensitive member (hereinafter, referred to as a “total current”), and the application voltage of the charging roller were modified so as to be adjusted and measured. In addition, power of each of a heater of a main body of the copying machine and a cassette heater was turned off before the use of the electrophotographic apparatus.

First, the electrophotographic apparatus and each of the electrophotographic photosensitive members according to the examples and the comparative examples were left under an environment of temperature of 30° C. and humidity of 80% RH as a high temperature and high humidity environment for 24 hours, and then each of the electrophotographic photosensitive members was mounted in the cyan station of the electrophotographic apparatus.

Next, as the application voltage of the charging roller, a direct current component was set to −700 V, a frequency of an alternating current component was set to 1,500 Hz, a potential Vpp between peaks was applied from −400 V to −2,000 V at 100 V intervals, and the total current at each application voltage was measured. Then, a graph with the Vpp on the horizontal axis and the total current on the vertical axis was created to obtain a Vpp at which a current amount deviated from a linear approximation curve at a Vpp from −400 V to −800 V (hereinafter, also referred to as a “discharge current amount) was 100 μA. The total current was set to a value of the total current amount at the application voltage at which the discharge current amount was 100 μA.

Next, the charging of the copying machine was set so that the dark part potential was −700 V. A solid image was output in a cyan single color on an A4 size plain paper, and the image exposure amount was set so that an initial density of the paper was 1.45±0.10 using a spectral density meter (manufactured by X-rite Inc.).

A square grid image having an A4 size, a line width of 0.1 mm, and a line interval of 10 mm was read from a scanner, and 5,000 sheets were continuously output in a cyan single color. After the image output, the main power of the electrophotographic apparatus was turned off and left for 3 days. After being left, the main power of the electrophotographic apparatus was turned on, one sheet of the square grid image was output in the same condition as described above, and image deletion on the output image was visually observed to evaluate the image deletion based on the following criteria.

Evaluation ranks were as follows.

Rank 6: The grid image was clearly output.

Rank 5: No abnormality was observed in the grid image.

Rank 4: The horizontal line on the grid image was broken, but no abnormality was observed in the vertical line.

Rank 3: The horizontal line on the grid image has disappeared, but no abnormality was observed in the vertical line.

Rank 2: The horizontal line on the grid image has disappeared, and the vertical line was broken.

Rank 1: The horizontal line on the grid image has disappeared, and the vertical line also has disappeared.

In this case, the horizontal line on the grid image refers to a line parallel to a cylindrical axis direction of the photosensitive member, and the vertical line on the grid image refers to a line perpendicular to the cylindrical axis direction of the photosensitive member. The results are shown in Table 1.

TABLE 1

| | | | | | | Polyvinyl acetal | | | |
|---|---|---|---|---|---|---|---|---|---|
| | | | | | | | | Used amount | Used amount |
| | Charge transporting | | Compound represented | | Used amount | | | with respect to | with respect to |
| | substance | | by Formula (1) | | of polytetra- | | | polytetra- | compound |
| | | Used | | Used | fluoroethylene | | Used | fluoroethylene | represented |
| | | amount | | amount | particle | Type of | amount | particle | by Formula (1) |
| | Compound | (parts) | Compound | (parts) | (parts) | material | (parts) | (% by mass) | (% by mass) |
| Example 1 | (H-19) | 55 | (1-3) | 20 | 30 | BL-10 | 1.2 | 4 | 6 |
| Example 2 | (H-19) | 55 | (1-3) | 20 | 30 | BM-1 | 1.2 | 4 | 6 |
| Example 3 | (H-16) | 55 | (1-3) | 20 | 30 | BL-10 | 1.2 | 4 | 6 |
| Example 4 | (H-19) | 55 | (1-4) | 20 | 30 | BL-10 | 1.2 | 4 | 6 |
| Example 5 | (H-19) | 55 | (1-1) | 20 | 30 | BL-10 | 1.2 | 4 | 6 |
| Example 6 | (H-19) | 55 | (1-1) | 20 | 30 | BM-1 | 1.2 | 4 | 6 |
| Example 7 | (H-5) | 55 | (1-1) | 20 | 30 | BL-10 | 1.2 | 4 | 6 |
| Example 8 | (H-5) | 55 | (1-1) | 20 | 30 | BM-1 | 1.2 | 4 | 6 |
| Example 9 | (H-5) | 55 | (1-1) | 20 | 30 | BL-10 | 2 | 6.7 | 10 |
| Example 10 | (H-5) | 55 | (1-1) | 20 | 30 | BL-10 | 0.9 | 3 | 4.5 |
| Example 11 | (H-5) | 55 | (1-1) | 20 | 30 | BL-10 | 3 | 10 | 15 |
| Example 12 | (H-5) | 55 | (1-1) | 20 | 30 | BL-10 | 0.3 | 1 | 1.5 |
| Example 13 | (H-5) | 55 | (1-1) | 20 | 30 | BL-10 | 4.5 | 15 | 22.5 |
| Example 14 | (H-5) | 55 | (1-1) | 30 | 20 | BM-1 | 0.8 | 4 | 2.7 |
| Example 15 | (H-5) | 65 | (1-1) | 30 | 10 | BM-1 | 0.4 | 4 | 1.3 |
| Example 16 | (H-5) | 65 | (1-1) | 10 | 30 | BL-10 | 1.2 | 4 | 12 |
| Example 17 | (H-5) | 70 | (1-1) | 5 | 30 | BL-10 | 1.2 | 4 | 24 |
| Example 18 | (H-5) | 50 | (1-1) | 25 | 30 | BL-10 | 1.2 | 4 | 4.8 |
| Example 19 | (H-5) | 35 | (1-1) | 40 | 30 | BL-10 | 1.2 | 4 | 3 |
| Example 20 | (H-15) | 35 | (1-1) | 40 | 30 | BL-10 | 1.2 | 4 | 3 |
| Example 21 | (H-5) | 35 | (1-1) | 40 | 30 | BL-10 | 0.9 | 3 | 2.3 |
| Example 22 | (H-5) | 35 | (1-1) | 40 | 30 | BL-10 | 3 | 10 | 7.5 |
| Example 23 | (H-5) | 35 | (1-1) | 40 | 30 | BL-10 | 0.32 | 1.1 | 0.8 |
| Example 24 | (H-5) | 35 | (1-1) | 40 | 30 | BL-10 | 4.5 | 15 | 11.3 |
| Comparative | (H-5) | 35 | *1 | 40 | 30 | BL-10 | 1.2 | 4 | — |
| Example 1 | | | | | | | | | |
| Comparative | (H-5) | 35 | *2 | 40 | 30 | BL-10 | 1.2 | 4 | — |
| Example 2 | | | | | | | | | |
| Comparative | (H-15) | 35 | (1-1) | 40 | 30 | *3 | 1.2 | — | — |
| Example 3 | | | | | | | | | |

| | Content of charge | Electrophotographic evaluation | | |
|---|---|---|---|---|
| | transporting substance | Potential | Image definition | |
| | in composition | fluctuation ΔVL | (fine line | Image |
| | (% by mass) | (V) | reproducibility) | deletion |
| Example 1 | 51.7 | 6 | A | 6 |
| Example 2 | 51.7 | 7 | A | 6 |
| Example 3 | 51.7 | 5 | A | 6 |
| Example 4 | 51.7 | 7 | A | 6 |
| Example 5 | 51.7 | 8 | A | 5 |
| Example 6 | 51.7 | 7 | A | 5 |
| Example 7 | 51.7 | 10 | A | 5 |
| Example 8 | 51.7 | 12 | A | 5 |
| Example 9 | 51.4 | 13 | A | 5 |
| Example 10 | 51.9 | 10 | A | 5 |
| Example 11 | 50.9 | 13 | A | 4 |
| Example 12 | 52.2 | 11 | C | 5 |
| Example 13 | 50.2 | 15 | C | 4 |
| Example 14 | 51.9 | 12 | A | 5 |
| Example 15 | 61.6 | 11 | A | 5 |
| Example 16 | 61.1 | 10 | A | 4 |
| Example 17 | 65.9 | 10 | A | 4 |
| Example 18 | 47.0 | 15 | B | 5 |
| Example 19 | 32.9 | 16 | B | 5 |
| Example 20 | 32.9 | 17 | B | 4 |
| Example 21 | 33.0 | 16 | B | 5 |
| Example 22 | 32.4 | 18 | B | 5 |
| Example 23 | 33.2 | 15 | D | 5 |
| Example 24 | 31.9 | 18 | D | 4 |
| Comparative | 32.9 | 23 | B | 2 |
| Example 1 | | | | |
| Comparative | 32.9 | 18 | B | 2 |
| Example 2 | | | | |
| Comparative | 32.9 | 26 | E | 4 |
| Example 3 | | | | |

*1: Comparative Compound No. 1 is used instead of compound represented by Formula (1).
*2: Comparative Compound No. 2 is used instead of compound represented by Formula (1).
*3: Fluorine surfactant (FTERGENT DFX-18) is used instead of polyvinyl butyral.

As a result of the evaluation, it is shown that the electrophotographic photosensitive member according to the example can reduce the potential fluctuation, increase the image reproducibility under a low humidity environment, and suppress the image deletion under a high temperature and high humidity environment, during repeated use of the electrophotographic photosensitive member.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2019-141215, filed Jul. 31, 2019 which is hereby incorporated by reference herein in its entirety.

What is claimed is:

1. An electrophotographic photosensitive member comprising: a support, a photosensitive layer provided on the support, and a surface layer provided on the photosensitive layer,
wherein the surface layer contains a cured product of a composition containing a charge transporting substance having a polymerizable functional group, a compound represented by the following Formula (1), a fluororesin particle, and polyvinyl acetal, 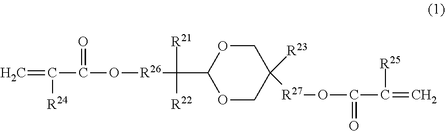
in Formula (1), R²¹ and R²² each independently represent an alkyl group having 1 or more and 4 or fewer carbon atoms or a substituted or unsubstituted aryl group, a substituent included in the aryl group is an alkyl group having 4 or fewer carbon atoms, R²¹ and R²² may be bonded to each other to form a ring,
R²³ represents an alkyl group having 1 or more and 4 or fewer carbon atoms, R²⁴ and R²⁵ each independently represent a hydrogen atom or a methyl group, and and R²⁷ each independently represent an alkylene group having 1 or more and 4 or fewer carbon atoms.

2. The electrophotographic photosensitive member according to claim 1, wherein a content of the polyvinyl acetal in the composition is 3.0% by mass or more and 10.0% by mass or less with respect to a content of the fluororesin particle in the composition.

3. The electrophotographic photosensitive member according to claim 1, wherein a content of the polyvinyl acetal in the composition is 0.8% by mass or more and 10.0% by mass or less with respect to a content of the compound represented by Formula (1) in the composition.

4. The electrophotographic photosensitive member according to claim 1, wherein a content of the charge transporting substance in the composition is 50% by mass or more with respect to a total content of the charge transporting substance, the compound represented by Formula (1) in the composition, the fluororesin particle, and the polyvinyl acetal.

5. The electrophotographic photosensitive member according to claim 1, wherein at least one of R²¹ and R²² in Formula (1) is an alkyl group having 2 or more carbon atoms.

6. A process cartridge integrally supporting an electrophotographic photosensitive member and at least one unit selected from the group consisting of a charging unit, a developing unit, and a cleaning unit, and being detachably attachable to a main body of an electrophotographic apparatus,
wherein the electrophotographic photosensitive member includes a support, a photosensitive layer provided on the support, and a surface layer provided on the photosensitive layer, and
the surface layer contains a cured product of a composition containing a charge transporting substance having a polymerizable functional group, a compound represented by the following Formula (1), a fluororesin particle, and polyvinyl acetal, 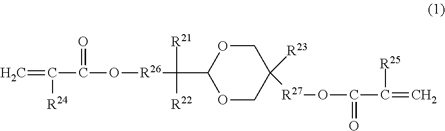
in Formula (1), R²¹ and R²² each independently represent an alkyl group having 1 or more and 4 or fewer carbon atoms or a substituted or unsubstituted aryl group,
a substituent included in the aryl group is an alkyl group having 4 or fewer carbon atoms, R²¹ and R²² may be bonded to each other to form a ring,
R²³ represents an alkyl group having 1 or more and 4 or fewer carbon atoms, R²⁴ and R²⁵ each independently represent a hydrogen atom or a methyl group, and R²⁶ and R²⁷ each independently represent an alkylene group having 1 or more and 4 or fewer carbon atoms.

7. An electrophotographic apparatus comprising: an electrophotographic photosensitive member, a charging unit, an exposing unit, a developing unit, and a transfer unit,
wherein the electrophotographic photosensitive member includes a support, a photosensitive layer provided on the support, and a surface layer provided on the photosensitive layer, and
the surface layer contains a cured product of a composition containing a charge transporting substance having a polymerizable functional group, a compound represented by the following Formula (1), a fluororesin particle, and polyvinyl acetal, 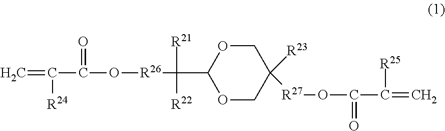
in Formula (1), R²¹ and R²² each independently represent an alkyl group having 1 or more and 4 or fewer carbon atoms or a substituted or unsubstituted aryl group,
a substituent included in the aryl group is an alkyl group having 4 or fewer carbon atoms, R²¹ and R²² may be bonded to each other to form a ring, R²³ represents an alkyl group having 1 or more and 4 or fewer carbon atoms, R²⁴ and R²⁵ each independently represent a hydrogen atom or a methyl group, and R²⁶ and R²⁷ each independently represent an alkylene group having 1 or more and 4 or fewer carbon atoms.
